(19) United States
(12) Patent Application Publication
(10) Pub. No.: US 2026/0133698 A1
(43) Pub. Date: May 14, 2026

(54) DATA MANAGENMENT METHOD, DEVICE AND COMPUTER-READABLE MEDIUM

(71) Applicant: MediaTek Singapore Pte. Ltd., Singapore (SG)

(72) Inventor: Guochun MAO, Anhui (CN)

(21) Appl. No.: 18/947,260

(22) Filed: Nov. 14, 2024

(51) Int. Cl. G06F 3/06

(52) U.S. Cl. CPC G06F 3/0616; G06F 3/064; G06F 3/0659; G06F 3/0679

(57) ABSTRACT

A data management method, device and computer-readable storage medium are provided. In the data management method, a data operation request corresponding to a first memory block is obtained, operation environment information corresponding to the data operation request is determined, a second memory block is determined according to the operation environment information, and an operation is performed on the second memory block according to the data operation request. The operation environment information includes application information and memory block wear information. The wear level of the second memory block is less than that of the first memory block. The data management method helps extend the life of a storage device.

### BACKGROUND OF THE INVENTION

### Field of the Invention

The present invention relates to the field of storage technology, and, in particular, to a data management method, device, and computer-readable storage medium.

### Description of the Related Art

Memory is a general term for electronic, magnetic, laser, chemical and other products that store data temporarily or long-term. Recently, flash memory has developed rapidly. Flash memory is a non-volatile memory that can erase and reprogram memory cells (called “blocks”). Any write operation of flash memory can only be performed on empty or erased memory cells. Therefore, in most cases, an erase operation must be performed before a write operation can begin.

Take NAND flash as an example: Each memory block may become a bad block after a certain number of erase/write operations. Therefore, the number of erase/write operations of a memory block will affect the product lifespan of the memory device.

### BRIEF SUMMARY OF THE INVENTION

To solve the above problems, the present application provides a data management method, device and computer-readable storage medium, which help a storage device extend it life.

A technical solution adopted in the present application is to provide a data management method. The data management method includes obtaining a data operation request corresponding to a first memory block. The data management method further includes determining operation environment information corresponding to the data operation request. The operation environment information includes application information and memory block loss information. The data management method further includes determining a second memory block based on the operation environment information. The wear level of the second memory block is less than that of the first memory block. The data management method further includes performing an operation on the second memory block based on the data operation request.

In one embodiment, after the step of performing the operation on the second memory block based on the data operation request, the data management method further includes determining a data movement strategy according to the operation environment information, moving data in a third memory block to a fourth memory block according to the data movement strategy. The wear level of the fourth memory block is less than that of the third memory block.

In one embodiment, the steps of determining the second memory block based on the operation environment information and determining a data movement strategy according to the operation environment information includes utilizing a target neural network model that is trained to process the operation environment information to determine the second memory block and the data movement strategy.

In an optional embodiment, after the step of performing the operation on the second memory block based on the data operation request, the data management method further performs data movements on the remaining memory blocks. Data from other memory blocks with higher wear levels is moved to a memory block with a lower wear level. This further balances the wear levels of all memory blocks and thereby extends the life of the storage device.

### BRIEF DESCRIPTION OF THE DRAWINGS

In order to more clearly illustrate the technical solutions in the embodiments of the present invention, the following briefly introduces the drawings used for describing the embodiments. Obviously, the drawings described below are only some embodiments of the present invention. For one skilled in the art, other drawings can be obtained based on these drawings without creative work.

FIG. 1 is a flow chart of a first embodiment of a data management method provided by the present application;

FIG. 2 is a schematic diagram of a data operation corresponding to FIG. 1;

FIG. 3 is a flow chart of a second embodiment of the data management method provided by the present application;

FIG. 4 is a flow chart of an embodiment of step 33 in FIG. 3;

FIG. 5 is a schematic diagram of a data operation corresponding to FIG. 4;

FIG. 6 is a flow chart of a third embodiment of the data management method provided by the present application;

FIG. 7 is a schematic diagram of a structure of the first embodiment of the data management device provided by the present application.

FIG. 8 is a schematic structural diagram of a second embodiment of the data management device provided by the present application;

FIG. 9 is a schematic diagram of a structure of an embodiment of a computer-readable storage medium provided by the present application.

### DETAILED DESCRIPTION OF THE INVENTION

The technical solutions in the embodiments of the present application will be clearly and completely described below with the drawings in the embodiments of the present application. Understandably, the specific embodiments described herein are only used for explaining the present application, rather than to limit the present application. It should also be noted that, for ease of description, only some but not all structures related to the present application are shown in the drawings. Based on the embodiments in the present application, all other embodiments obtained by one skilled in the art without making creative work are within the scope of protection of the present application.

The terms “first”, “second”, etc. in this application are used for distinguishing different objects, rather than to describe a specific order. In addition, the terms “include” and “comprise” and any variations are intended to cover non-exclusive inclusions. For example, a process, method, system, product or device including a series of steps or units is not limited to the listed steps or units, but optionally includes steps or units that are not listed, or optionally includes other steps or units inherent to these processes, methods, products or devices.

The term “embodiment” herein means that a particular feature, structure, or characteristic described in an embodiment may be included in at least one embodiment of the present application. The term in various locations in the specification does not necessarily refer to the same embodiment, nor is it an independent or alternative embodiment mutually exclusive with other embodiments. One skilled in the art should explicitly and implicitly understand that the embodiments described herein may be combined with other embodiments.

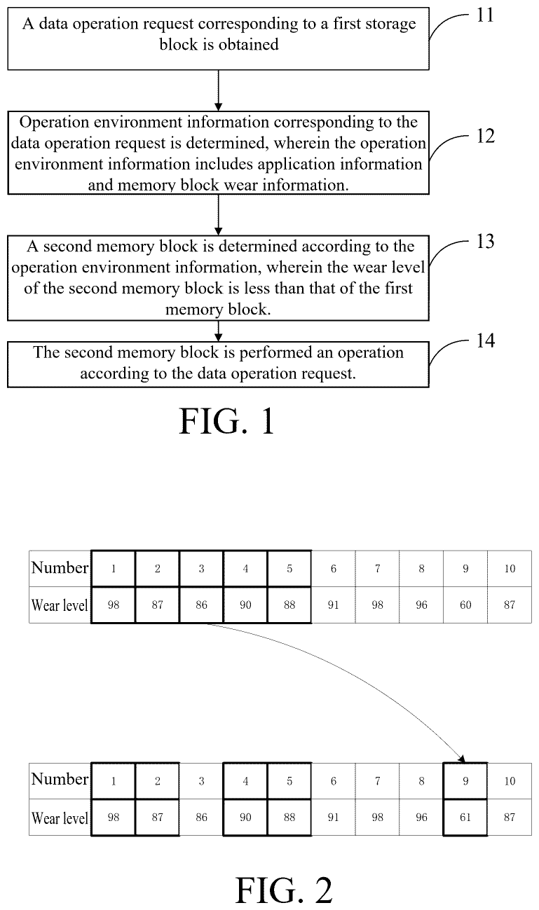

Referring to FIG. 1, FIG. 1 is a schematic flow chart of a first embodiment of a data management method provided by this application. The method includes:

Step 11: A data operation request corresponding to a first memory block is obtained.

Optionally, the data operation request is used for requesting an operation on the first memory block, specifically including any of a read request, a write request (i.e., a programming request), and an erase request.

Understandably, the data operation request is generally initiated by an application (APP). Take social APPs as an example: A picture received from a friend through a social APP is initially cached in a memory. If a user needs to save the picture into an album, the user can generate the data operation request by clicking on the picture and selecting a “save to album” option. Similarly, when using an album APP, the user can delete the pictures in it. Specifically, the user can click on the picture and select a “delete” option to generate the above data operation request. In addition to the above application scenarios, the data operation request can also be used for downloading songs in a music APP, saving files in an office APP, downloading videos in a video APP, etc. Examples are not provided one by one here.

Step 12: Operation environment information corresponding to the data operation request is determined, wherein the operation environment information includes application information and memory block wear information.

The operation environment information is current operation environment information corresponding to the received data operation request. In one embodiment, the operation environment information can be refreshed in real time based on preset rules. For example, the operation environment information is refreshed based on a preset time interval. Alternatively, the operation environment information is refreshed immediately when the data operation request is received.

The application information is information related to the application that initiated the data operation request. In an optional embodiment, the application information may include one or more of application type, application urgency level, and application memory usage.

Optionally, application types can be classified according to application functions. For example, application types can include social APP, game APP, audio and video multimedia APP, office APP, and data processing APP. Understandably, different application types have different requirements for data management. For example, social APP (e.g., WeChat) generally stores pictures. Office APP (e.g., Office) generally stores text. These two application types have low storage requirements. For another example, game APP requires immediacy in data storage and no delay. Data processing APP (e.g., video editing) requires storage for large amount of data.

Optionally, application urgency level can be determined according to a running status of the application. For example, a foreground application can be considered to have a high urgency level, while a background application can be considered to have a low urgency level. Alternatively, the application urgency level can be determined based on historical usage data (i.e., user habits) of the application. For example, if the user uses a music APP at 8-9 o'clock every day, then the music APP is considered to have a high urgency level between 8-9 o'clock every day.

Optionally, application memory usage can be determined based on memory usage of a central processing unit (CPU). An application with high memory usage may process related data currently.

Memory block wear information is the wear level as determined by the write/erase count. The wear level can directly be the erase count and be expressed in numbers. Alternatively, it can be a ratio of the erase count to the estimated number of erase cycles and be expressed in percentage. For example, if the estimated number of erase cycles of a TLC NAND flash memory block is 2,000 and the erase count is 500, then the wear level can be expressed as 500, or 500/2000.

In an optional embodiment, the memory block wear information includes one or more of single block wear level, total wear level, and average wear level. The single block wear level is the wear level of each memory block. The total wear level is the sum of the wear levels of all memory blocks. The average wear level is an average of the wear levels of all memory blocks.

Step 13: A second memory block is determined according to the operation environment information, wherein the wear level of the second memory block is less than that of the first memory block.

Understandably, the application information, the memory block wear information and the first memory block corresponding to the data operation request are determined in step 12. In some application scenarios, according to the application information and the memory block loss information, if the data operation is performed on the original first memory block, the effect of the data operation or the life of the storage device may be affected.

For example, the application is found to be a music APP according to the application information. According to the user's habits, the music APP usually downloads songs, saves these songs in the memory. These songs may be in the memory for a long time and has no change. Therefore, the second memory block with more erase count (but less than the estimated number of erase cycles) can be selected for data writing. For another example, the application is found to be a game APP according to the application information. According to the user's habits, data of the game APP is often updated. Therefore, the second memory block with fewer erase count can be selected for data writing.

Take the first memory block corresponding to the data operation request as an example: The erase count of the first memory block is greater than the average erase count of all memory blocks. Therefore, the second memory block with the erase count that is less than the average erase count of all memory blocks can be selected for data writing.

Step 14: The second memory block is performed an operation according to the data operation request.

Referring to FIG. 2, FIG. 2 is a schematic diagram of a data operation corresponding to FIG. 1. For example, the memory block numbered “3” is the first memory block determined according to the data operation request. That is to say, the block address is calculated based on the data operation request to determine the first memory block. Its corresponding wear level (erase count) is 86. According to distribution of the wear levels of all memory blocks, there are still memory blocks with lower wear levels, e.g., the memory block numbered “9”. Its corresponding wear level is 60. Therefore, it can be used as the second memory block. That is, the corresponding operation is performed on the memory block numbered “9” according to the data operation request.

Further, referring to FIG. 2, when only the memory block wear information is considered, the corresponding operation is performed on the memory block numbered “9” instead of the requested memory block numbered “3”. If the memory block wear information and the application information are both considered, a different result may be generated. For example, the application initiating the data operation request is an image processing APP (e.g., Photo shop). According to the user's historical usage data, the image processing APP is frequently used. Each time it is used, operations such as writing and erasing pictures are performed. Therefore, the memory block numbered “9” can be selected for the corresponding operations. For another example, the application initiating the data operation request is a cloud storage APP. According to the user's historical usage data, the cloud storage APP is rarely used. Generally, the data written won't be modified. The subsequent operations are mostly read operations. Therefore, considering the memory block wear information and the application information, the memory block numbered “3” is still selected for the corresponding operations.

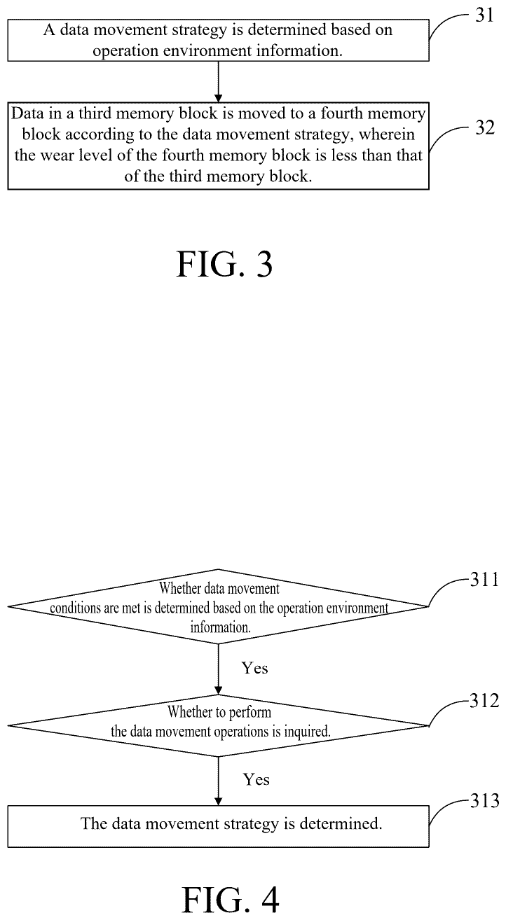

In another embodiment, in addition to the above selection of the memory block, whether to move the data in the memory block can also be determined after the data operations are performed. Specifically, referring to FIG. 3, FIG. 3 is a flow chart of a second embodiment of the data management method provided by the present application. The data management method includes:
Step 31: A data movement strategy is determined based on the operation environment information.

The data movement strategy performs data movements on other memory blocks after the corresponding operations are performed on the second memory block according to the data operation request.

Understandably, in response to the corresponding operations on the second memory block, the total wear level and the average wear level of the storage device, for example, change. Therefore, determining whether the storage device needs to move data based on these changes can help the storage device extend its life.

Optionally, in an embodiment, as shown in FIG. 4, FIG. 4 is a flow chart of an embodiment of step 31 in FIG. 3. Specifically, step 31 may include:

Step 311: Whether data movement conditions are met is determined based on the operation environment information.

Optionally, whether the data movement conditions are met is determined mainly based on two factors, the application information and the memory block wear information.

On the one hand, the memory block wear information can be stored to determine the single block wear level. Then, whether to move the data of the memory block with a larger single block wear level is determined. Alternatively, the memory block wear information can be stored to determine the total wear level and the average wear level. Then, whether to move the data of the memory block with a higher-than-average wear level is determined.

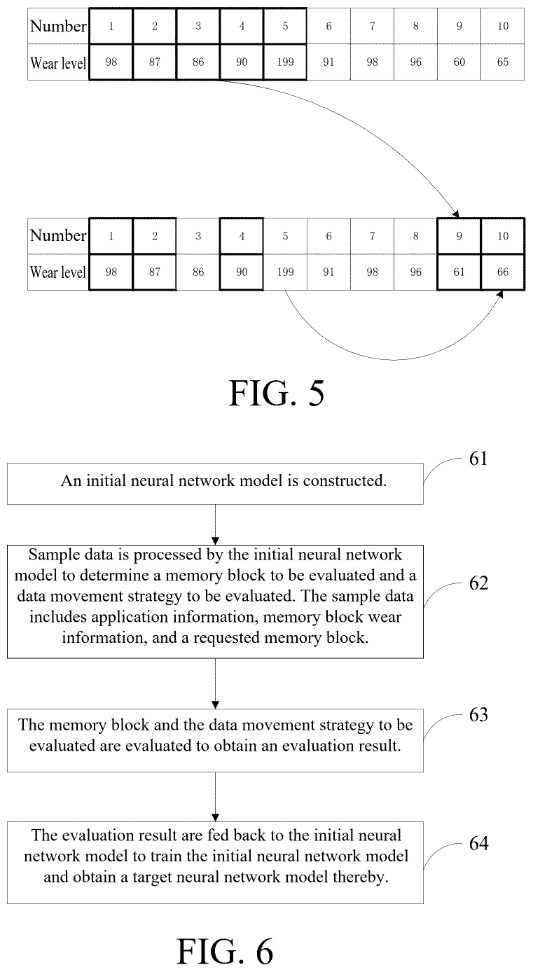

As shown in FIG. 5, FIG. 5 is a schematic diagram of a data operation corresponding to FIG. 4. For example, the first memory block determined according to the data operation request is the memory block numbered “3”. Its corresponding wear level (erase count) is 86. According to the distribution of the wear levels of all memory blocks, there are still memory blocks with lower wear levels, e.g., the memory block numbered “9”. Its corresponding wear level is 60. Therefore, it can be used as the second memory block. That is, the corresponding operations are performed on the memory block numbered “9” according to the data operation request. Then, the distribution of the wear levels of all memory blocks is further analyzed. The wear level of the memory block numbered “5” is found to be 199, which is much greater than those of other memory blocks. Accordingly, the data movement conditions are determined to be met.

On the other hand, in addition to the wear level, the application information can further be considered. In FIG. 5, for example, the memory block numbered “5” is determined to meet the movement conditions based on its wear level. The data stored in the memory block numbered “5” is determined to be not suitable for data movement based on the application type, application urgency level or application memory usage. Therefore, it is finally determined that the memory block numbered “5” does not meet the data movement conditions.

For example, the data stored in the memory block numbered “5” is the data of a game APP. The game APP is currently running. Therefore, it can be determined that the memory block numbered “5” does not meet the data movement conditions.

Step 312: If the data movement conditions are met, whether to perform the data movement operations is inquired.

Step 313: In response to the inquiry, the data movement strategy is determined if a data movement instruction is received.

Optionally, step 312 may be performed by a pop-up dialog box with “yes” and “no” buttons displayed. When an instruction generated by the user clicking the “yes” button is received, the data movement strategy is determined.

Step 32: Data in a third memory block is moved to a fourth memory block according to the data movement strategy, wherein the wear level of the fourth memory block is less than that of the third memory block.

Referring to FIG. 5 again, the memory block numbered “5” can be used as the third memory block. The memory block numbered “10” with a lower wear level can be used as the fourth memory block. The data in the third memory block can be moved to the fourth memory block.

Notably, the third memory block and the fourth memory block here can be any two memory blocks. That is, the third memory block can be the first memory block or the second memory block in the above embodiment. The fourth memory block can also be the first memory block or the second memory block in the above embodiment. Of course, the third memory block and the fourth memory block can also be other memory blocks except the first memory block and the second memory block.

Understandably, the above-mentioned determination on the data movement mainly considers the wear levels of memory blocks and the relevant application information. In another embodiment, the above-mentioned determination on the data movement further considers a current CPU load. It takes CPU resources to move data. Therefore, it can be decided not to move data temporarily when the CPU load is high. When the CPU load gets lower, it can be decided to move data.

Understandably, in combination with the above two embodiments, in one application scenario, the above step 31 can be executed after step 14. That is, after the second memory block is determined according to the operation environment information and is performed the operation, the subsequent data movement is performed. In a second application scenario, the embodiments of steps 31 and 32 can be executed separately and independently of the embodiments of steps 11-14. In a third application scenario, the embodiments of steps 31 and 32 can be executed synchronously with the embodiments of steps 11-14. For example, steps 13 and 31, i.e., determining the second memory block and the data movement strategy according to the operation environment information, can be executed synchronously.

The data management method provided in this embodiment includes obtaining a data operation request corresponding to a first memory block. The data management method further includes determining operation environment information corresponding to the data operation request. The operation environment information includes application information and memory block wear information. The data management method further includes determining a second memory block according to the operation environment information. The wear level of the second memory block is less than that of the first memory block. The data management method further includes performing an operation on the second memory block according to the data operation request. Through the above data management method, the memory block required for the data operation is selected based on the distribution of the wear levels of memory blocks and the application information corresponding to the operation environment information. With the characteristic of the current application considered, the memory block with a lower wear level can be performed the operation first. This makes the wear levels of all memory blocks relatively balanced, and thereby generally extend the life of the storage device.

In an optional embodiment, after the second memory block is performed the operation, the remaining memory blocks can be further performed data movement. Data from other memory blocks with higher wear levels is moved to memory blocks with lower wear levels. This further makes the wear levels of all memory blocks more balanced, and thereby extends the life of the storage device.

Based on the first and second embodiments above, a neural network model can be further configured to, according to the user's usage habits, select the operating memory block and determine whether data movement is required.

First, a training procedure of the neural network model is introduced. Referring to FIG. 6, FIG. 6 is a flow chart of a third embodiment of the data management method provided by the present application. The method includes:

Step 61: An initial neural network model is constructed.

Neural network (NN) is a complex network system formed by a large number of simple processing units (called neurons) that are widely interconnected. It reflects many basic characteristics of human brain functions and is a highly complex nonlinear dynamic learning system. It has large-scale parallel, distributed storage and processing, self-organization, self-adaptation and self-learning capabilities. It is particularly suitable for processing imprecise and fuzzy information processing problems that require considering many factors and conditions at the same time.

In this embodiment, convolutional neural network, long short-term memory neural network, feedforward neural network, etc. can be used, and are not limited here.

Step 62: Sample data is processed by the initial neural network model to determine a memory block to be evaluated and a data movement strategy to be evaluated. The sample data includes application information, memory block wear information, and a requested memory block.

The sample data here may be experimental data, or may be historical data corresponding to the user's historical data operations. Understandably, the sample data is massive, including multiple experimental data or historical data corresponding to multiple data operations. Each experimental data or historical data may include application information, memory block wear information, and a requested memory block.

Specifically, the sample data is input into and processed by the initial neural network model. Take convolutional neural networks as an example: The processing procedure may specifically include feature extraction (convolution), pooling, feature connection, normalization and output. Then, the memory block to be evaluated and the data movement strategy to be evaluated are output.

Optionally, in another embodiment, the sample data may also include processor load information.

Step 63: The memory block and the data movement strategy are evaluated to obtain an evaluation result.

Optionally, the evaluation result may indicate whether the memory block or the data movement strategy to be evaluated meets the requirements.

For example, if the wear level of the memory block to be evaluated is determined to be less or lower than the average wear level, or be the lowest wear level among those of all memory blocks, then the memory block to be evaluated can be considered to meet the requirements. For example, if the data movement strategy to be evaluated is to move data from a memory block with a higher wear level to another with a lower wear level when the application is in the background and the processor load is low, then the data movement strategy to be evaluated can also be considered to meet the requirements.

For another example, if the wear level of the memory block to be evaluated is greater than the average wear level, then the memory block to be evaluated can be considered to be not meet the requirements. For example, if the data movement strategy to be evaluated is to move data from one memory block to another when the application is in the foreground and the memory usage is high, then the data movement strategy to be evaluated can be considered to not meet the requirements.

Step 64: The evaluation result are fed back to the initial neural network model to train the initial neural network model and obtain a target neural network model thereby.

Optionally, for the evaluation result indicating that the memory block to be evaluated and the data movement strategy to be evaluated meet the requirements, it can be directly fed back. For the evaluation result indicating that the memory block to be evaluated and the data movement strategy to be evaluated do not meet the requirements, it can be directly fed back, or a memory block and a movement strategy determined to meet the requirements by other means can also be fed back to the initial neural network model. This makes the initial neural network model modify its network parameters to achieve the purpose of training.

Understandably, each sample data needs to go through the above-mentioned process of step 62, step 63 and step 64. Massive sample data is configured to train the initial neural network model continuously to obtain the target neural network model.

The trained target neural network model is configured to process the operation environment information to determine the second memory block and the data movement strategy.

In combination with the third embodiment described above, the neural network model is trained by sample data mainly. Since the neural network model has large-scale parallel, distributed storage and processing, self-organization, self-adaptation and self-learning capabilities, it is able to perform good feature extraction on information (e.g., application information, memory block wear information and the first memory block corresponding to the data operation request), and thereby gets trained and learns. Therefore, when selecting memory blocks and determining data movements, the neural network model refers to sample data to take user habits into account, instead of using a fixed manner. Therefore, the result can be more consistent with user's needs. Unnecessary operations inconsistent with user's needs are avoided. This reduces the power consumption of the storage device.

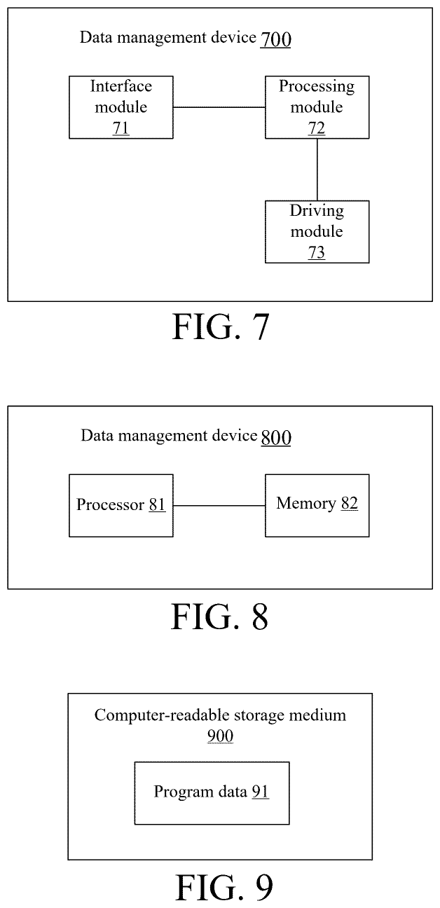

Referring to FIG. 7, FIG. 7 is a schematic diagram of a structure of the first embodiment of the data management device provided by the present application. The data management device 700 includes an interface module 71, a processing module 72 and a driving module 73.

The interface module 71 is configured to obtain a data operation request corresponding to a first memory block. The processing module 72 is configured to determine operation environment information corresponding to the data operation request, and determine the second memory block according to the operation environment information. The operation environment information includes application information and memory block wear information. The wear level of the second memory block is less than that of the first memory block. The driving module 73 is configured to perform an operation on the second memory block according to the data operation request.

Optionally, the interface module 71 is specifically a data access service interface mainly configured to obtain a data operation request sent by an application. The processing module 72 is connected to the interface module 71. On the one hand, the processing module 72 receives the data operation request obtained by the interface module 71. On the other hand, the processing module 72 obtains the operation environment information. The processing module 72 determines the second memory block according to the data operation request and the operation environment information. The driving module 73 then performs an operation on the second memory block according to the data operation request.

In one embodiment, the processing module 72 is specifically a neural network module configured to process the operation environment information to determine the second memory block and the data movement strategy. The driving module 73 is configured to perform an operation on the second memory block according to the data operation request, and move the data in the third memory block to the fourth memory block according to the data movement strategy.

Referring to FIG. 8, FIG. 8 is a schematic diagram of a structure of the second embodiment of the data management device provided by the present application. The data management device 800 includes a processor 81 and a memory 82.

The memory 82 is configured to store program data. The processor 81 is configured to execute the program data to implement the following method. The method includes obtaining a data operation request corresponding to a first memory block. The method further includes determining operation environment information corresponding to the data operation request. The operation environment information includes application information and memory block wear information. The method further includes determining a second memory block according to the operation environment information. The wear level of the second memory block is less than that of the first memory block. The method further includes perform an operation on the second memory block according to the data operation request.

Optionally, the data management device in the embodiments of FIGS. 7 and 8 above can be a PC, a laptop, a mobile phone, a tablet computer, a smart wearable device (e.g., a watch, glasses), etc. The memory 92 can be a flash memory, e.g., a NAND flash memory.

Referring to FIG. 9, FIG. 9 is a structural diagram of an embodiment of a computer-readable storage medium provided by the present application. The computer-readable storage medium 900 stores program data 91. When executed by the processor, the program data 91 implements the following method. The method includes obtaining a data operation request corresponding to a first memory block. The method further includes determining operation environment information corresponding to the data operation request. The operation environment information includes application information and memory block wear information. The method further includes determining a second memory block according to the operation environment information. The wear level of the second memory block is less than that of the first memory block. The method further includes performing an operation on the second memory block according to the data operation request.

Optionally, the computer-readable storage medium 900 mentioned above may be a flash memory, e.g., a NAND flash memory.

In the several embodiments provided in this application, it should be understood that the disclosed methods and devices can be implemented in other ways. For example, the device embodiments described above are only illustrative. For example, the division of the modules or units is only a logical function division. There may be other division methods in actual implementation. For example, multiple units or components can be combined or integrated into another system, or some features can be ignored or not executed.

The units described as separate components may or may not be physically separated. The components shown as units may or may not be physical units. That is, they may be located in one place or distributed on multiple network units. Some or all of the units may be selected according to actual needs to achieve the purpose of the embodiments.

In addition, each functional unit in each embodiment of the present application may be integrated into one processing unit, or may exist physically separately. Alternatively, two or more functional units may be integrated into one. The integrated unit above may be implemented in the form of hardware or in the form of software functional units.

If the integrated units in other embodiments above are implemented in the form of software functional units and sold or used as independent products, they can be stored in a computer-readable storage medium. Based on this comprehension, the essence or the part that contributes to the current technology or all of the technical solution of the present application can be implemented in the form of a software product. The computer software product is stored in a storage medium, including several instructions. The instructions enable a computer device (e.g., a personal computer, server, or network device, etc.) or a processor to perform all or part of the steps of the method described in each embodiment of the present application. The aforementioned storage medium includes a universal serial bus (USB), a mobile hard disk, a read-only memory (ROM), a random access memory (RAM), a disk, an optical disk and others that can store program code.

The above descriptions are only implementations of the present application, and does not limit the patent scope of the present application. Any equivalent structure or equivalent change on process made according to the descriptions and drawings of the present application, or directly or indirectly applied in other related technical fields, are also included in the patent protection scope of the present application.

What is claimed is:

1. A data management method, comprising:
obtaining a data operation request corresponding to a first memory block;
determining operation environment information corresponding to the data operation request, wherein the operation environment information comprises application information and memory block wear information;
determining a second memory block according to the operation environment information, wherein a wear level of the second memory block is less than that of the first memory block; and
performing an operation on the second memory block according to the data operation request.

2. The data management method as claimed in claim 1, wherein the step of performing the operation on the second memory block according to the data operation request further comprises:
determining a data movement strategy according to the operation environment information; and
moving data in a third memory block to a fourth memory block according to the data movement strategy, wherein a wear level of the fourth memory block is less than that of the third memory block.

3. The data management method as claimed in claim 2, wherein the step of determining the second memory block according to the operation environment information and the step of determining the data movement strategy according to the operation environment information comprises:
utilizing a target neural network model that is trained to process the operation environment information to determine the second memory block and the data movement strategy.

4. The data management method as claimed in claim 3, further comprising:
constructing an initial neural network model;
utilizing the initial neural network model to process sample data to determine a memory block to be evaluated and a data movement strategy to be evaluated, wherein the sample data comprises the application information, the memory block wear information and a requested memory block;
evaluating the memory block to be evaluated and the data movement strategy to be evaluated to obtain an evaluation result; and
feeding the evaluation result back to the initial neural network model to train the initial neural network model to obtain the target neural network model.

5. The data management method as claimed in claim 4, wherein the application information comprises one or more of application type, application urgency level and application memory usage.

6. The data management method as claimed in claim 5, wherein the application urgency level is determined based on application historical usage data.

7. The data management method as claimed in claim 5, wherein the memory block wear information includes one or more of single block wear level, total wear level and average wear level.

8. The data management method as claimed in claim 5, wherein the sample data and the operation environment information further comprise processor load information.

9. The data management method as claimed in claim 2, wherein the step of determining the data movement strategy according to the operation environment information comprises:
determining whether a data movement condition is met based on the operation environment information;
making an inquiry about whether to perform a data movement, if the data movement condition is met; and
determining the data movement strategy, if a data movement instruction is received in response to the inquiry.

10. The data management method as claimed in claim 1, further comprising:
calculating a block address based on the data operation request to determine the first memory block.

11. The data management method as claimed in claim 1, wherein the data operation request comprises one or more of a read request, a write request and an erase request.

12. A data management device, comprising:
an interface module, configured to obtain a data operation request corresponding to a first memory block;
a processing module, configured to determine operation environment information corresponding to the data operation request, and to determine a second memory block according to the operation environment information, wherein the operation environment information comprises application information and memory block wear information, wherein a wear level of the second memory block is less than that of the first memory block; and
a driving module, configured to perform an operation on the second memory block according to the data operation request.

13. A computer-readable storage medium, configured to store program data, wherein the program data implements the data management method as claimed in claim when executed by a processor.
